(19) United States
(12) Patent Application Publication
(10) Pub. No.: US 2015/0072306 A1
(43) Pub. Date: Mar. 12, 2015

(54) ORAL ULTRASOUND WAVEGUIDE DEVICE

(71) Applicant: dBMEDx Inc, Littleton, CO (US)

(72) Inventors: William L. Barnard, Maple Valley, WA (US); David B. Shine, Littleton, CO (US)

(21) Appl. No.: 14/481,807

(22) Filed: Sep. 9, 2014

Related U.S. Application Data
(60) Provisional application No. 61/876,018, filed on Sep. 10, 2013.

(51) Int. Cl. A61C 17/20

(52) U.S. Cl. CPC A61C 17/20
USPC 433/98; 433/119; 433/216

(57) ABSTRACT

An oral ultrasound waveguide device is disclosed for use as an oral cleaning device. One embodiment includes a power source and an ultrasonic oscillator configured to be positioned outside an oral cavity, and a waveguide configured to couple ultrasonic energy from the ultrasonic oscillator to a mouth portion configured to be received in an oral cavity. The mouth portion can be configured to couple the ultrasonic energy outward from the mouth portion via at least one matching layer.

### BACKGROUND

1. Technical Field

The present disclosure relates generally to oral cleaning devices, systems, and techniques, and more particularly to ultrasound devices that may be utilized as oral cleaning devices.

2. Description of the Related Art

Over the years several different oral cleaning devices have been proposed that use some form of sonic modality. By far the majority of these have been 20-40 kHz mechanically vibrated toothbrushes. This 20-40 kHz frequency range is also used for some professional dental hygienist teeth scraping tools. The 20-40 kHz frequency range mechanical devices have been very commercially successful. There has been a much more limited market for a true ultrasound device with a carrier frequency over 1 MHz, despite research evidence of the utility of a true ultrasound device. Shinada K, Hashizume L, Teraoka K, and Kurosaki, N, Effect of Ultrasonic Toothbrush on Streptococcus Mutans, Japan J. Conserv. Dent., 1999; 42 (2): 410-417. For example, Megasonex markets a 1.6 MHz ultrasound toothbrush.

The 20-40 kHz frequency range mechanical toothbrushes remove plaque using the same basic mechanism as a manual toothbrush. They have a big advantage of making it easier to ensure good brushing technique and aiding compliance with a 120 second “egg timer” approach. A true MHz ultrasound device fundamentally uses a different modality to remove plaque. The ultrasound can directly vibrate and disrupt the plaque biofilm as well as explode small air bubbles at the surface of the tooth that create tiny fluidic jets which disrupt plaque and tooth biofilm in general.

An ultrasonic tooth cleaning device in the form of a mouth-guard device that distributes ultrasonic transducers around the teeth is proposed in U.S. Pat. No. 7,044,737. This patent teaches the desirability of both a true ultrasound modality and the mouth-guard topology to bring the ultrasound in close proximity to the teeth.

U.S. Pat. No. 7,044,737 specifies that the ultrasound transducers are disposed inside the oral cavity which limits the transducer size, increases the bulkiness of the device in the mouth, adds complexity, and requires safeguards to insure the high voltages on the transducers are isolated from the user. If the transducers could be moved outside the mouth it would solve many of these problems, but directing the energy to the desired surfaces of the teeth with an external transducer is difficult.

### BRIEF SUMMARY

An oral ultrasound waveguide device may be summarized as including: a first portion sized and dimensioned to be received in an oral cavity when the device is in use, the first portion comprising a teeth or mouth guard portion, the teeth or mouth guard portion at least initially conformable to a set of teeth; a second portion coupled to the first portion to be positioned outwardly of the oral cavity when the device is in use, the second portion comprising a power source and at least one ultrasonic oscillator powered via the power source; and at least one guide positioned in the device to couple ultrasonic energy from the at least one ultrasonic oscillator to the first portion, the first portion further comprising a number of matching layers that couple ultrasonic energy received from the at least one ultrasonic oscillator via the at least one guide outwardly from the first portion.

The at least one guide may include brass and at least a portion of the guide has an hour glass cross-sectional profile. The teeth or mouth guard portion may include a low temperature thermoforming material.

An oral ultrasound waveguide device may be summarized as including: a control module including a power source and at least one ultrasonic transducer powered by the power source to generate ultrasonic energy; a mouth guard, at least a portion of the mouth guard positionable inside of a mouth of a user; and a sonic waveguide element physically coupled to the at least one ultrasonic transducer and to the mouth guard to communicatively couple the ultrasonic energy generated by the ultrasonic transducer outside of the mouth of the user to at least the portion of the mouth guard positionable inside the mouth of the user.

The sonic waveguide element may include a high impedance metal. The sonic waveguide element may include brass. The sonic waveguide element may have an acoustic impedance approximating an acoustic impedance of the at least one ultrasonic transducer. The at least one ultrasonic transducer may include a PZT material. The waveguide element may be surrounded by one or more air gaps, the one or more air gaps isolated from an external ambient environment. The at least one ultrasonic transducer may be a flat ultrasonic transducer. The mouth guard may be physically coupled to the sonic waveguide element via a plurality of matching layers. The matching layers may enhance transmission of the ultrasonic energy from the waveguide element to at least the portion of the mouth guard. The mouth guard may include a low temperature shape memory thermoplastic polymer. The mouth guard may include a hydrophilic material.

The oral ultrasound waveguide device may further include a button to activate the device in response to the user biting down on at least the portion of the mouth guard.

The oral ultrasound waveguide device may further include a hardware-only controller.

A method may be summarized as including: generating ultrasonic energy at a first location outside of a mouth of a user; guiding the ultrasonic energy from the first location through an ultrasonic waveguide element to a mouth guard at a second location within the user's mouth; and guiding the ultrasonic energy from the mouth guard to the user's teeth.

The method may further include, prior to generating ultrasonic energy, retaining a shape of the teeth of the user in response to an insertion of the mouth guard into position and a clenching of the teeth of the user on the mouth guard.

The method may further include, prior to generating ultrasonic energy, absorbing a plurality of bubbles into the mouth guard.

Generating ultrasonic energy may be activated by the user biting down on a button.

### BRIEF DESCRIPTION OF THE SEVERAL VIEWS OF THE DRAWINGS

FIG. 1 is a side view of several components of an embodiment of an oral ultrasound waveguide device.

FIG. 2 is a possible top view of several components of an oral ultrasound waveguide device such as that shown in FIG. 1.

FIG. 3 is a side view of the oral ultrasound waveguide device of FIG. 1 with additional components shown.

FIG. 4 is a possible top view of several components of an oral ultrasound waveguide device such as that shown in FIG. 1.

FIG. 5 is a top isometric view of an embodiment of an oral ultrasound waveguide device.

FIG. 6 is a partial cutaway illustration of the oral ultrasound waveguide device of FIG. 5 with additional components visible.

FIGS. 7 and 8 are additional top isometric views of the oral ultrasound waveguide device of FIG. 5.

FIG. 9 is a side view of a switch for activating an oral ultrasound waveguide device.

FIG. 10 is a top view of the switch of FIG. 9.

FIG. 11 is a top view of a portion of an oral ultrasound waveguide device including holes for positioning portions of switches as shown in FIG. 9 beneath the teeth of a user when the oral ultrasound waveguide device is in use.

### DETAILED DESCRIPTION

This application describes a novel architecture and waveguide. As shown in the figures, in the described devices 100, 200, the electronics (e.g., printed circuit boards (PCBs) 112, 212), batteries (e.g., 110, 210), and transducers (e.g., 104, 204) are advantageously located outside of the oral cavity in a small control module. The ultrasound energy is generated outside of the mouth and is transmitted inside to surfaces of the teeth via a unique and novel sonic waveguide (e.g., 102). By controlling the surface acoustic impedances and the specific reflective surfaces of the waveguide (e.g., 102), the locations where the ultrasound is contained and where it is designed to exit can be controlled.

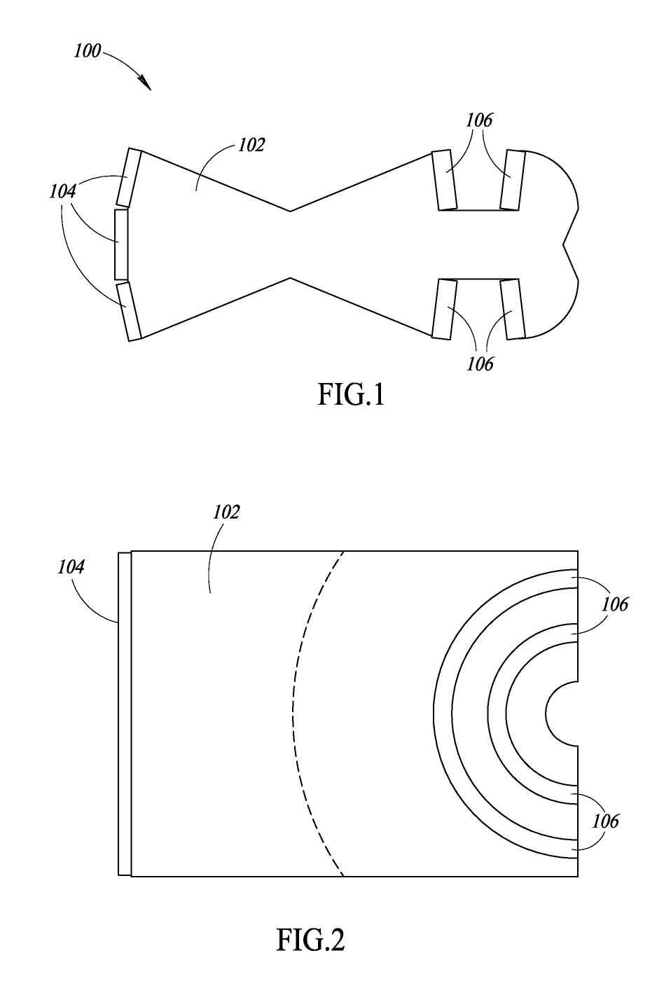

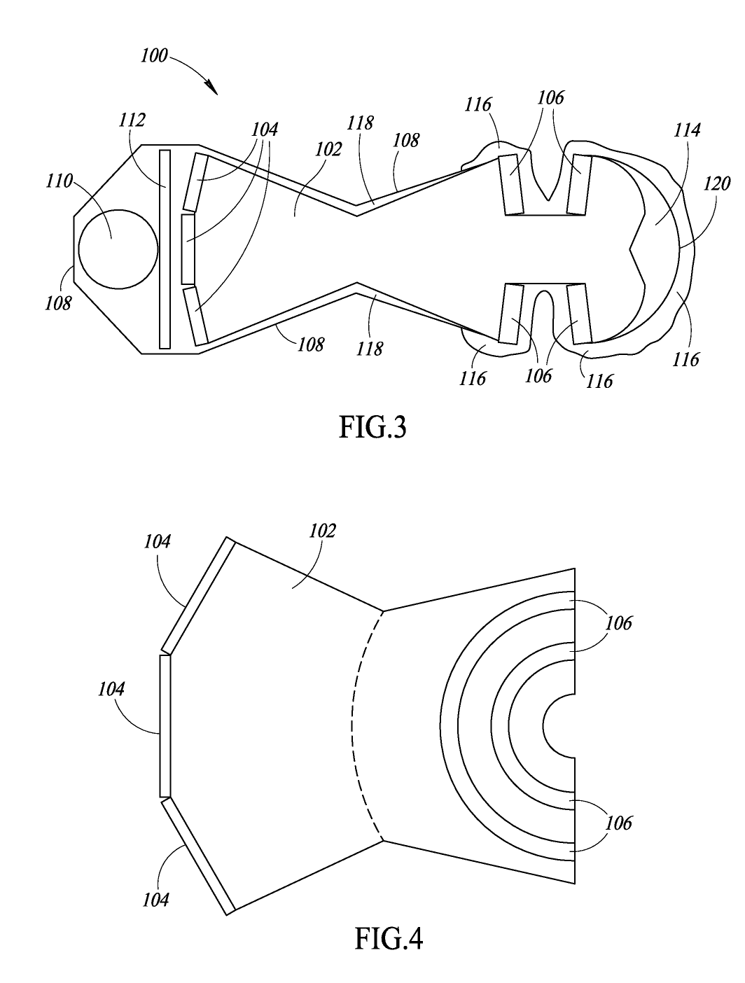

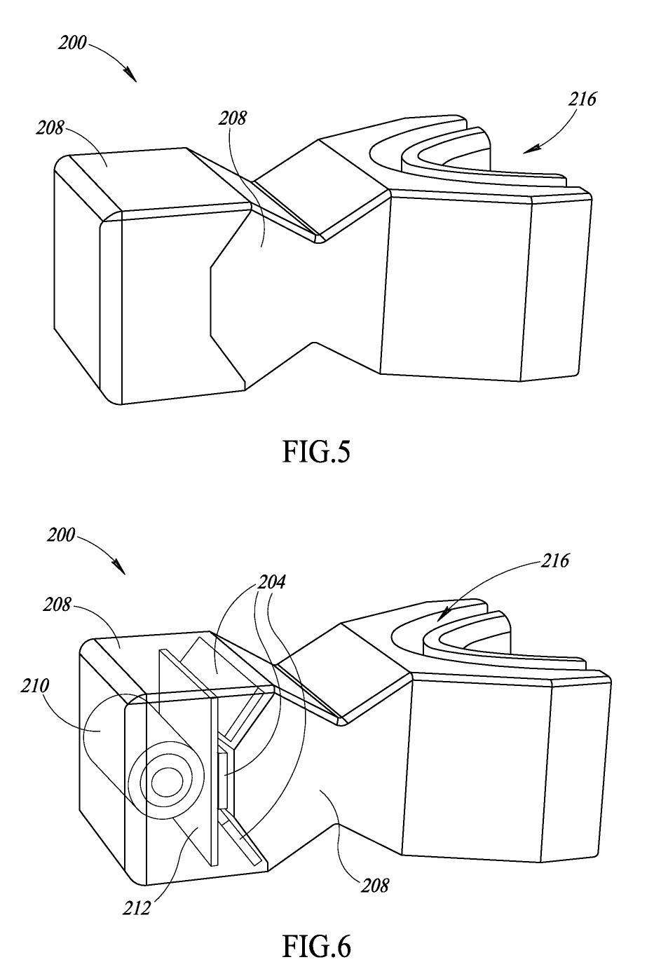

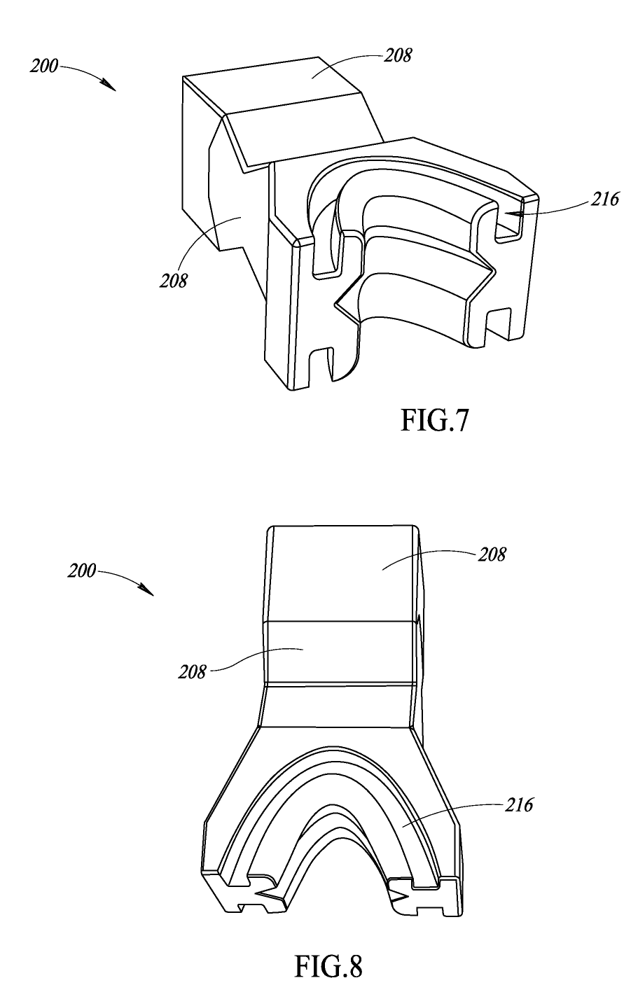

As shown in FIGS. 1 and 3, the ultrasound energy is injected into a high impedance metal such as brass which serves as the primary ultrasound waveguide element 102. Brass has an acoustic impedance (such as, e.g., about 40.6 Mrayl, which can be contrasted with an acoustic impedance of about 0.8 Mrayl for silicone) that is close to a hard PZT (lead zirconium titanate) transducer material, as opposed to aluminum which would be a typical matching layer for therapeutic ultrasound transducer configuration. Utilizing brass or a similar high impedance material such as stainless steel provides a more efficient energy transfer out of the transducers 104. The high acoustic impedance brass material is surrounded by air gaps 114, 118 which have very low acoustic impedances and this mismatch serves to create a total internal reflection at these surfaces which confines the ultrasound energy inside the brass waveguide 102. The waveguide element 102 and air gaps 114, 118 can be enclosed by metallic, plastic, or silicone rubber shells 108, 208, 120.

In the areas of the brass waveguide 102 where emission of the ultrasound energy from the waveguide 102 is desired, near the teeth, two or more matching layers 106 designed to enhance the transmission from the high impedance brass waveguide 102 down to the much lower impedance polymer mouth guard piece 116 can be included. This allows the device 100 to actually steer and distribute the ultrasound energy into the mouth and onto the desired surfaces of the teeth. The brass waveguide 102 also serves to focus and concentrate the ultrasonic energy allowing the use of less expensive flat transducers 104 rather than a curved transducer. Various shapes are possible for the brass waveguide 102 and examples are shown in the figures.

The devices described herein eliminate the need for a fluidic coupling material in a trough. The teeth or mouth guards 116, 216 described herein are made of a low temperature shape memory thermoplastic polymer that can be formed just like any sports teeth or mouth guard. The user can place at least the teeth or mouth guard portion 116, 216 of the device 100, 200 in hot water to soften the polymer and then insert the device into the teeth or mouth guard portion of the mouth and hold it in place with the teeth loosely clenched for a few seconds. As the polymer cools it will retain the exact shape of the user's teeth, creating a custom fit that brings the material precisely to the surface of the teeth. This minimizes the air gap between the final layer in the acoustic path of the device 100, 200 prior to hitting the teeth surfaces.

In addition, the mouth guard material is slightly hydrophilic and absorbs water and the user can store the entire mouth guard portion 116, 216 of the device 100, 200 in either water or a special tooth paste solution that is loaded with engineered nano-bubbles. Over a period of time, ranging from 1 hour to 24 hours depending on the solution and material, the polymer absorbs the solution and becomes loaded with the fluid and nano-bubbles. Once the device is placed in the mouth and activated for a period of time ranging from, for example, 10 seconds to 5 minutes, the fluid in the polymer will be sufficient to couple the ultrasound energy to the teeth and provide a reservoir of nano-bubbles that can be activated. Optionally the solution can have anti-microbial, whitening, anti-plaque and/or anti-tartar properties.

Optionally, a switch may activate the device, for example, when the user places the device in the mouth. The switch can be activated by softly biting down on the mouth guard 116, 216 to hold it in the mouth in a manner similar to that used for a SCUBA regulator. Alternatively, the switch can be a proximity sensor, temperature sensor, or other sensor that detects when the mouth guard is inserted into the mouth. This switch can be a pneumatic tube created in the brass waveguide 102 with a larger entrance opening in the section between the teeth and a smaller exit opening in the section that abuts the PCB. A pressure sensor on the PCB can sense slight changes in pressure when the unit is placed in a closed mouth. Alternatively, the entrance section can be covered and sealed with the mouth guard material and a piston can be placed in the exit tube that pushes on a momentary switch mounted on the PCB. The piston can be a solid rod or simply a closed membrane. The larger section of air pushing on a smaller exit orifice can increase the activation force.

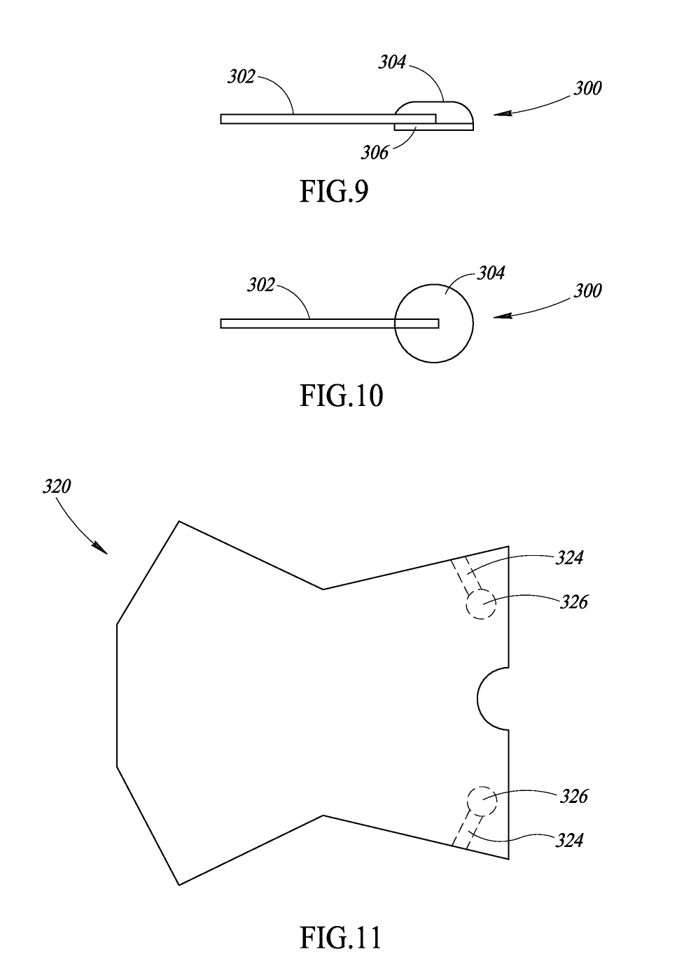

Another possible activation device 300 is illustrated in FIGS. 9-11. FIGS. 9-11 illustrate running a wire 302 alongside a brass waveguide 320 and ultimately through holes 324 that position the end of the wire 302 beneath the teeth within wells 326. When the user bites down, they push on a mechanical rod (stiff foam or plastic) which pushes a thin metallic button dome 304 that collapses and shorts the activation wire 302 to the brass waveguide 320. When the user releases their jaws and pressure is removed, the button dome 304 pops back up and contact with the activation wire 302 is broken. The activation device 300 can also include a non-conductive disc 306 to hold the activation wire 302 within a well 326. The brass waveguide 320 is electrically grounded and the entire system creates a normally open switch. The brass waveguide 320 can include two sets of holes 324 and wells 326, each of which can hold a respective activation device 300, for example, for redundancy.

Another basic solution can be an actual manual switch on the control module itself that is pressed by the user to initiate cleaning. In all cases, the device 100, 200 can shut down after the programmed dose is administered, or when removed from the mouth if such occurs before completion of the programmed dose.

To indicate when the device 100, 200 is actively cleaning teeth, a simple LED or similar indicator can be visible while the device 100, 200 is clamped in the mouth. If the LED is lit, the device is active. Once the cycle is complete the LED can turn off or blink momentarily to indicate successful completion. In an embodiment, the entire device 100, 200 is sealed and can be washed under a faucet. The battery 110, 210 is internal and is a primary cell lithium-ion battery (e.g., a CR123A lithium-ion battery) with enough power to last for 6 months to a year at prescribed usage rates. Battery life can also be indicated with a simple LED scheme while the device is active, for example, a simple “idiot light” that indicates there is only some limited number of uses remaining.

The control is simple enough that it is possible to replace a true microprocessor with a much simpler hardware-only controller. The absence of software simplifies the regulatory hurdles and potentially lowers production costs. This embodiment uses a single counter that gets clocked with an oscillator at twice the frequency of the ultrasound carrier frequency. The least significant bit (LSB) of the counter, gated by additional logic derived from the higher bits, drives the transducer amplifier. The number of bits of counter resolution determines how long the device needs to stay active.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including U.S. provisional patent application No. 61/876,018, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a first portion sized and dimensioned to be received in an oral cavity when the device is in use, the first portion comprising a teeth or mouth guard portion, the teeth or mouth guard portion at least initially conformable to a set of teeth;
a second portion coupled to the first portion to be positioned outwardly of the oral cavity when the device is in use, the second portion comprising a power source and at least one ultrasonic oscillator powered via the power source; and
at least one guide positioned in the device to couple ultrasonic energy from the at least one ultrasonic oscillator to the first portion, the first portion further comprising a number of matching layers that couple ultrasonic energy received from the at least one ultrasonic oscillator via the at least one guide outwardly from the first portion.

2. The device of claim 1 wherein the at least one guide comprises brass and at least a portion of the guide has an hour glass cross-sectional profile.

3. The device of claim 1 wherein the teeth or mouth guard portion comprises a low temperature thermoforming material.

4. A device, comprising:
a control module including a power source and at least one ultrasonic transducer powered by the power source to generate ultrasonic energy;
a mouth guard, at least a portion of the mouth guard positionable inside of a mouth of a user; and
a sonic waveguide element physically coupled to the at least one ultrasonic transducer and to the mouth guard to communicatively couple the ultrasonic energy generated by the ultrasonic transducer outside of the mouth of the user to at least the portion of the mouth guard positionable inside the mouth of the user.

5. The device of claim 4 wherein the sonic waveguide element comprises a high impedance metal.

6. The device of claim 4 wherein the sonic waveguide element comprises brass.

7. The device of claim 4 wherein the sonic waveguide element has an acoustic impedance approximating an acoustic impedance of the at least one ultrasonic transducer.

8. The device of claim 4 wherein the at least one ultrasonic transducer comprises a PZT material.

9. The device of claim 4 wherein the waveguide element is surrounded by one or more air gaps, the one or more air gaps isolated from an external ambient environment.

10. The device of claim 4 wherein the at least one ultrasonic transducer is a flat ultrasonic transducer.

11. The device of claim 4 wherein the mouth guard is physically coupled to the sonic waveguide element via a plurality of matching layers.

12. The device of claim 11 wherein the matching layers enhance transmission of the ultrasonic energy from the waveguide element to at least the portion of the mouth guard.

13. The device of claim 4 wherein the mouth guard comprises a low temperature shape memory thermoplastic polymer.

14. The device of claim 4 wherein the mouth guard comprises a hydrophilic material.

15. The device of claim 4, further comprising a button to activate the device in response to the user biting down on at least the portion of the mouth guard.

16. The device of claim 4, further comprising a hardware-only controller.

17. A method, comprising:
generating ultrasonic energy at a first location outside of a mouth of a user;
guiding the ultrasonic energy from the first location through an ultrasonic waveguide element to a mouth guard at a second location within the user's mouth; and
guiding the ultrasonic energy from the mouth guard to the user's teeth.

18. The method of claim 17, further comprising, prior to generating ultrasonic energy, retaining a shape of the teeth of the user in response to an insertion of the mouth guard into position and a clenching of the teeth of the user on the mouth guard.

19. The method of claim 17, further comprising, prior to generating ultrasonic energy, absorbing a plurality of bubbles into the mouth guard.

20. The method of claim 17 wherein generating ultrasonic energy is activated by the user biting down on a button.
